(19) United States
(12) Patent Application Publication
(10) Pub. No.: US 2006/0031565 A1
(43) Pub. Date: Feb. 9, 2006

(54) High speed packet-buffering system

(76) Inventors: Sundar Iyer, Palo Alto, CA (US); Nick McKeown, Palo Alto, CA (US); Jeff Chou, Foster City, CA (US)

Correspondence Address: Dag Johansen, P.O. Box 7512, Menlo Park, CA, 94025, US

(21) Appl. No.: 11/182,731

(22) Filed: Jul. 15, 2005

Related U.S. Application Data
(60) Provisional application No. 60/588,741, filed on Jul. 16, 2004.

(51) Int. Cl. G06F 15/16

(52) U.S. Cl. 709/234; 709/235

(57) ABSTRACT

A number of techniques for implementing packet-buffering memory systems and packet-buffering memory architectures are disclosed. In one embodiment, a packet-buffering memory system comprises a high-latency memory sub system with a latency time of L and a low-latency memory subsystem. The low-latency memory subsystem contains enough memory to store an amount of packet data to last L seconds when accessed from low-latency memory subsystem at an access-rate of A. The packet-buffering system further comprises a FIFO controller that responds to a packet read request by simultaneously requesting packet data from said high-latency memory subsystem while simultaneously requesting and quickly responding with packet data obtained from the low-latency memory subsystem.

### RELATED APPLICATIONS

The present patent application claims the benefit of the previous U.S. Provisional Patent Application entitled “High Speed Packet-buffering System” filed on Jul. 16, 2004 having Ser. No. 60/588,741. The present patent application also hereby incorporates by reference in its entirety the U.S. patent application entitled “High Speed Memory Control and I/O Process System” filed on Dec. 17, 2004 having Ser. No. 11/016,572.

### FIELD OF THE INVENTION

The present invention relates to the field of memory control subsystems. In particular the present invention discloses various different high-speed memory subsystems for digital computer systems.

### BACKGROUND OF THE INVENTION

Modern digital networking devices must operate at very high speeds in order to accommodate every increasing line spends and large numbers of different possible output paths. Thus, it is very important to have a high-speed processor in a network device in order to be able to quickly process data packets. However, without an accompanying high-speed memory system, the high-speed network processor may not be able to temporarily store data packets at an adequate rate. Thus, a high-speed digital network device design requires both a high-speed network processor and an associated high-speed memory system.

One of the most popular techniques for creating a high-speed memory system is to implement a small high-speed cache memory system that is tightly integrated with the processor. Typically, a high-speed cache memory system duplicates a region of a larger slower main memory system. Provided that the needed instructions or data are within the small high-speed cache memory system, the processor will be able to execute at full speed (or close to full speed since sometimes the cache runs slower than the processor, but caches are generally much faster than the slower main memory system). When a cache ‘miss’ occurs (the required instruction or data is not available in the high-speed cache memory), the processor must then wait until the slower memory system responds with the needed instruction or data.

Cache memory systems provide a very effective means of creating a high-speed memory system for support of high-speed computer processors such that nearly every high-speed computer processor has a cache memory system. Such conventional cache memory systems may be implemented within network processors to improve the performance of network devices such as routers, switches, hubs, firewalls, etc. However, conventional cache memory systems typically require large amounts expensive low density memory technologies that consume larger amounts of power than standard dynamic random access memory (DRAM) that is typically used in main memory systems. For example, static random access memory (SRAM) technologies are often used to implement high-speed cache memory systems. Static random access memory (SRAM) integrated circuits typically cost significantly more and consume much more power than dynamic random access memory integrated circuits.

A much more important drawback of implementing a conventional high-speed cache memory system in the context of a network device is that a conventional cache memory system does not guarantee high-speed access to the desired data. Specifically, a conventional high-speed cache memory system will only provide a very fast response if the desired information is currently represented in the high-speed cache memory subsystem. With a good cache memory system design that incorporates clever heuristics that ensure the desired information is very likely to be represented in the cache memory subsystem, a memory system that employs a high-speed cache memory subsystem will provide a very fast memory response time on average. However, if the desired information is not currently represented in the cache memory subsystem, then a fetch to the main (slower) memory system will be required and the data will be delivered at the access rate of the slower main memory system.

Many networking applications require a guaranteed memory response time in order to operate properly. For example, if a networking device such as a router must have the next data packet ready to send out on the next time slot on an outgoing communication line then the memory system in the router that stores the data packet must have guaranteed response time. In such an application, a conventional cache memory system will not provide a satisfactory high-speed memory solution since the conventional high-speed cache memory subsystem only provides a fast response time on average, not all of the time. Thus, other means of improving memory system performance must be employed in such networking applications.

One simple method of creating a high-speed memory system that will provide a guaranteed response time is to construct the entire memory system from high-speed static random access memory (SRAM) devices. Although this method is relatively easy to implement, this method has significant drawbacks. For example, this method is very expensive, it requires a large amount of printed circuit board area, it generates significant amounts of heat, and it draws excessive amounts of electrical power.

Due to the lack of a guaranteed performance from conventional high-speed cache memory systems and the cost of building an entire memory system from high-speed SRAM, it would be desirable to find other ways of creating high-speed memory systems for network devices that require guaranteed memory performance. Ideally, such a high-speed memory system would not require large amounts of SRAM devices that are low-density, very expensive, consume a relatively large amount of power, and generate a relatively large amount of heat.

### SUMMARY OF THE INVENTION

A number of techniques for implementing packet-buffering memory systems and packet-buffering memory architectures are disclosed. In one embodiment, a packet-buffering memory system comprises a high-latency memory sub system with a latency time of L and a low-latency memory subsystem. The low-latency memory subsystem contains enough memory to store an amount of packet data to last L seconds when accessed from low-latency memory subsystem at an access-rate of A. The packet-buffering system further comprises a FIFO controller that responds to a packet read request by simultaneously requesting packet data from said high-latency memory subsystem while simultaneously requesting and quickly responding with packet data obtained from the low-latency memory subsystem.

Other objects, features, and advantages of present invention will be apparent from the accompanying drawings and from the following detailed description.

### BRIEF DESCRIPTION OF THE DRAWINGS

The objects, features, and advantages of the present invention will be apparent to one skilled in the art, in view of the following detailed description in which:

FIG. 1A illustrates a high-level block diagram of a packet-buffering memory system implemented within the context a generic network device.

FIG. 1B illustrates the packet-buffering memory system FIG. 1A with packet-buffer queues conceptually illustrated.

FIG. 2A illustrates a block diagram of a computer device having a processor and an SRAM memory system.

FIG. 2B illustrates a block diagram of a computer device having a processor and a traditional DRAM memory system.

FIG. 2C illustrates a block diagram of a ‘system on a chip’ computer device implemented with an embedded DRAM memory system.

FIG. 3 illustrates a block diagram of a generic network device implemented with an embedded DRAM based packet-buffering system.

FIG. 4 illustrates a block diagram of a generic network device containing a packet-buffering system that maintains two different queue tail pointers for each packet queue.

FIG. 5 illustrates a high-level block diagram of a computer device implemented with a high access-rate memory system made from embedded DRAM.

FIG. 6 illustrates a timing diagram that illustrates how the high access-rate memory system of FIG. 5 may operate.

FIG. 7 illustrates a block diagram of a typical packet-buffering system constructed according to the teachings of the present invention.

FIG. 8 conceptually illustrates a packet-buffering system that pads a data block written to the high-latency memory system when packets do not evenly fit in the data block.

FIG. 9 conceptually illustrates a packet-buffering system that efficiently packs data packets into a data block written to or read from the high-latency memory system.

FIG. 10 illustrates a flow diagram that describes how a packet-buffering controller that efficiently packs data packets into a data block reacts to packet write requests.

FIG. 11 illustrates a flow diagram that describes how a packet-buffering controller that efficiently packs data packets into a data block reacts to packet read requests.

FIG. 12A illustrates a block diagram of a network device implemented with four SRAM memory devices.

FIG. 12B illustrates a block diagram of a network device implemented packet-buffering subsystem that includes four virtual SRAM memory devices.

### DETAILED DESCRIPTION OF THE PREFERRED EMBODIMENT

A methods and apparatuses for implementing high-speed memory systems for digital computer systems are disclosed. In the following description, for purposes of explanation, specific nomenclature is set forth to provide a thorough understanding of the present invention. However, it will be apparent to one skilled in the art that these specific details are not required in order to practice the present invention. Similarly, although the present invention has been described with reference to packet-switched network processing applications, the same techniques can easily be applied to other types of computing applications. For example, any computing application that uses FIFO queues may incorporate the FIFO teachings of the present invention.

### Overall Packet-Buffering System

Methods for performing packet-buffering and a packet-buffering system are set forth described in the technical paper entitled “Designing Packet Buffers for Router Linecards” by ****. One of the packet-buffering techniques disclosed in that technical paper operates by using a small amount of expensive low-latency cache memory (which may be SRAM or embedded DRAM) and a larger amount of inexpensive high-latency memory (which may be DRAM or embedded DRAM) in a novel intelligent manner such that the packet-buffering system as a whole achieves a 100% cache hit rate. In that packet-buffering system an intelligent memory controller ensures that any data packets that may be needed in the near future are always available in the low-latency memory (SRAM) when requested. In this manner, the packet-buffering system is always able to provide a low-latency response to data packet read requests.

A Basic Packet-Buffering System Block Diagram

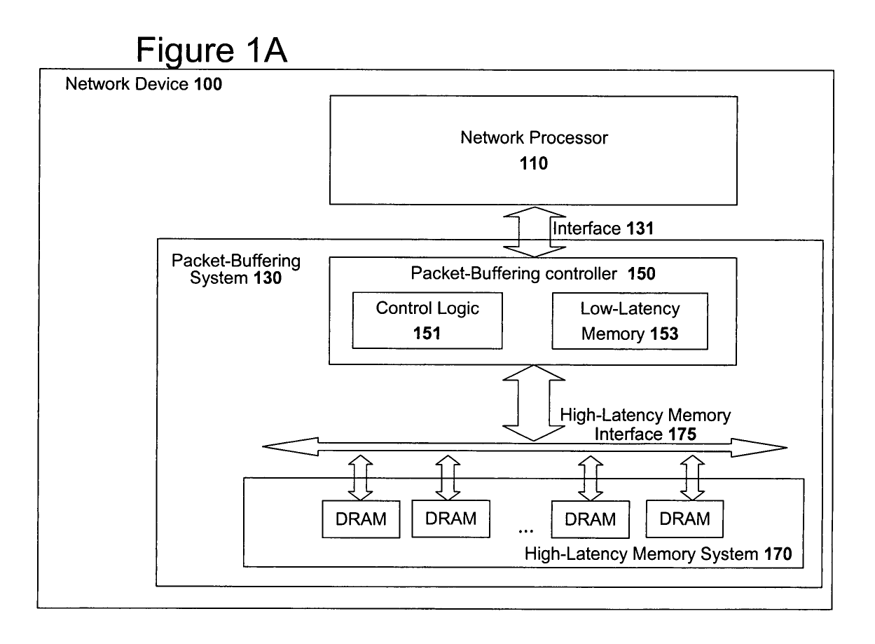

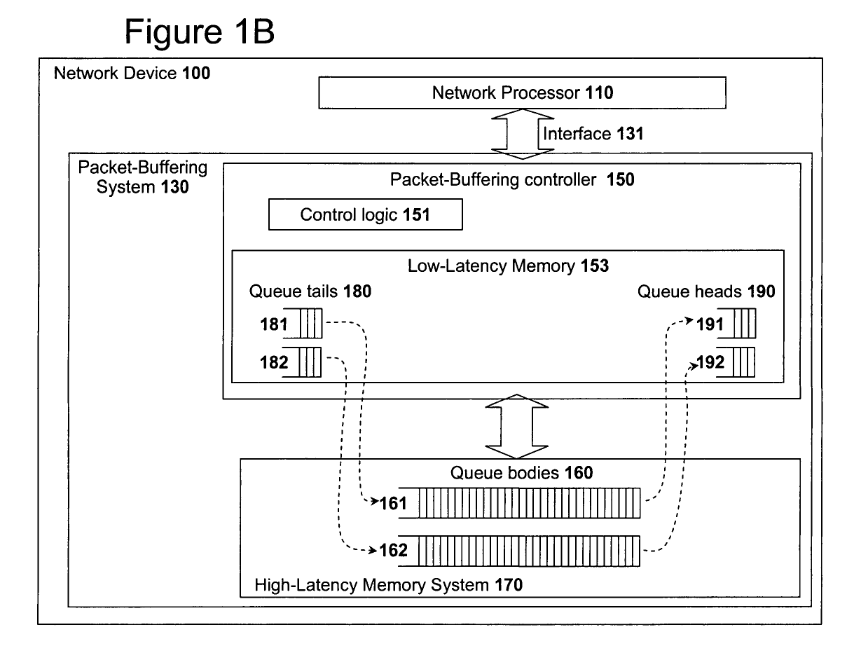

FIG. 1A illustrates a high-level block diagram of a packet-buffering system 130 of the present invention implemented within the context a generic digital networking device such as a router or a switch. As illustrated in FIG. 1A, the packet-buffering system 130 is coupled to a network processor 110. The packet-buffering system 130 provides the network processor 110 with memory access services such that the network processor 110 is able to achieve a higher level of performance than would be available using a normal memory system. Specifically, the packet-buffering system 130 off-loads a number of memory intensive tasks such as packet-buffering that would normally require a large amount of high-speed memory if the packet-buffering system 130 were not present.

The packet-buffering system 130 includes a packet-buffering controller 150 that may be implemented as an Application Specific Integrated Circuit (ASIC), a Field Programmable Gate Array (FPGA), or in another manner. The packet-buffering controller 150 may be considered as a specialized memory controller that is dedicated to perform the task of packet-buffering and other specific memory tasks needed for memory management in network device 100. The packet-buffering controller 150 includes control logic 151 that analyzes all of the memory requests received from the network processor 110 and responds to those memory requests in an appropriate manner.

To respond to memory requests from the network processor 110 very quickly, the packet-buffering controller 150 includes a limited amount of low-latency memory 153. The low-latency memory 153 may be built into the packet-buffering controller 150 (as illustrated in the embodiment of FIG. 1A) or off-chip as a discrete integrated circuit.

When designed properly, the control logic 151 of the packet-buffering controller 150 will be able to respond to any request from the network processor 110 quickly using its logic or using data located within the local low-latency memory 153. However, in addition to quickly responding to the network processor 110, the control logic 151 will also use a much larger but slower high-latency memory system 170 to store information from the network processor 110 that does not need to be read or updated immediately. To provide a high-memory bandwidth to the high-latency memory system, the high-latency memory interface 175 is implemented with a very wide data bus such that the data throughput of the high-latency memory interface 175 is at least as high as the data throughput of the interface 131 between network processor 110 and packet-buffering system 130. Note that the control logic 151 always immediately buffers received data from the network processor 110 in low-latency memory 153 and ensures that any data that may be read in the near future is available in low-latency memory 153 such that the packet-buffering system 130 appears to be one large monolithic low-latency memory system to the network processor 110.

To accomplish these desired goals, the intelligent control logic 151 takes advantage of the particular manner in which a network processor 110 typically uses its associated memory system. Specifically, the intelligent control logic 151 in the packet-buffering system 130 is optimized for the memory access patterns commonly used by network processors. For example, the packet-buffering system 130 is aware of both the types of data structures stored in the memory being used (such as FIFO queues used for packet buffering) and the fact that the reads and writes are always to the tails and heads of the FIFO queues, respectively.

A Basic Packet-Buffering System Conceptual Diagram

FIG. 1B illustrates a conceptual diagram of a packet-buffering system 130 that implements a pair of FIFO queues that may be used for packet-buffering. In the example of FIG. 1B, each the two FIFO queues are divided into three separate pieces: tails of the FIFO queues 180, the main bodies of the FIFO queues 160, and the heads of the FIFO queues 190. The tails of the FIFO queues (181 and 182) are where data packets are written to the queues. Correspondingly, the heads of the FIFO queues (191 and 192) are where data packets are read from the FIFO queues. Both the queue tails 180 and the queue heads 190 are stored in low-latency memory 153 for quick access by the network processor 110.

The main bodies of the FIFO queues (161 and 162), the center of the FIFO queues, are stored in high-latency memory 170. The control logic 151 moves data packets from the FIFO queue tails (181 and 182) into the FIFO queue bodies (161 and 162) and from the FIFO queue bodies (161 and 162) into the FIFO queue heads (191 and 192) as necessary to ensure that the network processor 110 always has low-latency access to the data packets in FIFO queue heads 190 and FIFO queue tails 180.

With the proper use of intelligent control logic 151 and a small low-latency memory 153, the packet-buffering system 130 will make a large high-latency memory system 170 (such as a DRAM memory system) appear to the network processor 110 as if it were constructed using all low-latency memory (such as SRAM). Thus, the packet-buffering system 130 is able to provide a memory system with the speed of an SRAM-based memory system using mainly the high-density, low-cost, and low-power consumption of a DRAM-based memory system.

### Memory Technology Overview

Modern computer systems may be constructed using many different types of memory technologies. However, new embedded DRAMs have been introduced that allow the packet-buffering systems of the present invention to be implemented in new ways. Before addressing these new embedded DRAM designs, an overview of existing memory system technologies is desirable. The main two memory technologies used today are static random access memories (SRAM) and dynamic random-access memories (DRAM).

Static Random Access Memory (SRAM)

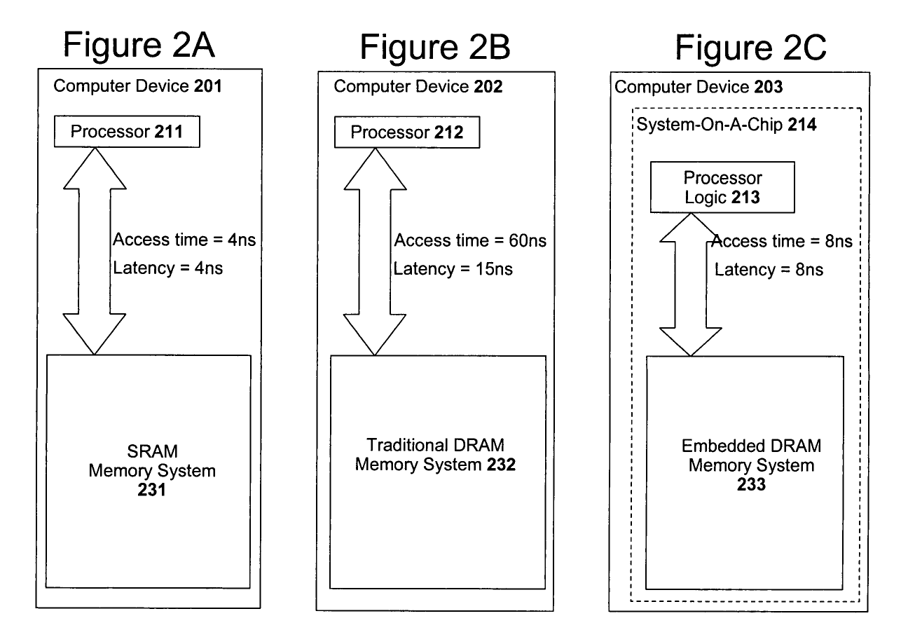

Static random access memories (SRAM) provide very high-performance memory services. Specifically, SRAM memory devices provide both a low access time (the amount of time that a memory device requires to elapse between success memory requests) and a low-latency time (the amount of time required for a memory device to respond with a piece of data after receiving a data request). For example, FIG. 2A illustrates a block diagram of a computer device 201 having a processor 211 coupled to an SRAM-based memory system 231. In the example of FIG. 2A, the SRAM-based memory system 231 has an access time of 4 nanoseconds (4 nanoseconds required between successive random memory access requests) and a latency period of 4 nanoseconds (a response to a memory access request cannot be expected until 4 nanoseconds have passed).

The high-performance provided by SRAM devices comes at a cost. Relative to other memory technologies, SRAM devices are lower density (store fewer bits per integrated circuit area), more expensive, consume more power, and generate more heat. Thus, static memory devices are generally used only for high-performance applications such as high-speed cache memories.

Traditional Dynamic Random Access Memory (DRAM)

Instead of using expensive high-performance SRAM, most computer systems use traditional dynamic random-access memory (DRAM) devices for their main memory system. Traditional DRAM devices are very inexpensive compared to SRAM devices. Furthermore, traditional DRAM devices consume less power, generate less heat, and are available in much higher-density formats. However, traditional DRAM devices do not provide high-performance that SRAM devices can provide. Typically traditional DRAM memory devices have a longer latency period than SRAM memory devices and also have a longer access time (slower access rate) as compared to SRAM memory devices.

FIG. 2B illustrates a block diagram of an example computer device 202 having a processor 212 and a traditional DRAM memory system 232. In the example of FIG. 2B, the traditional DRAM-based memory system 232 has an access time of 60 nanoseconds and a latency of 15 nanoseconds. Thus, traditional DRAM memory devices are significantly slower than SRAM memory devices in terms of both access rate and latency period. Furthermore, traditional DRAM memory devices require a special semiconductor manufacturing process that is not very compatible with the industry standard Complementary Metal-Oxide-Semiconductor (CMOS) manufacturing process used to implement most digital logic circuitry. Thus, traditional DRAM generally cannot be integrated with processors or within Applications Specific Integrated Circuits (ASICs).

### Embedded DRAM Memory Systems Overview

In recent years, a new type of DRAM memory device design has been introduced that allows DRAM memory to be built with the industry standard Complementary Metal-Oxide-Semiconductor (CMOS) manufacturing process. Such DRAM memory systems are known as ‘embedded DRAM’ systems since the DRAM may be embedded along with other digital logic circuitry implemented with the CMOS manufacturing process. Current embedded DRAM memory does not have the very high density of traditional DRAM devices. However, embedded DRAM memory provides much better performance than traditional DRAM memory.

FIG. 2C illustrates a block diagram of a computer device 203 containing a ‘system on a chip’ 214. The system on a chip 214 is implemented with processor logic 213 and an on-chip embedded DRAM memory system 233. In the example of FIG. 2C, the DRAM-based memory system 233 has an access time of 8 nanoseconds and a latency period of 8 nanoseconds. Since the embedded DRAM memory system 233 has an access time close to the access time of the SRAM memory system 231, the embedded DRAM memory system 233 may often be used in memory applications that would normally require higher performance SRAM memory. For example, if some parallelism can be incorporated into the memory system design then embedded DRAM devices can provide the same access rate performance as high performance SRAM. Furthermore, the embedded DRAM memory system 233 provides a very low-latency period in comparison to traditional DRAM (although not as low as high-performance SRAM).

### FIFO Memory Services Implemented With Embedded DRAM Memory

As set forth in the method for performing packet-buffering described in the paper entitled “Designing Packet Buffers for Router Linecards”, 100% hit-rate high-speed packet-buffering in First-In First-Out (FIFO) queues may be achieved by using a small amount of expensive high access-rate and low-latency cache memory (which may be SRAM) along with a larger amount of inexpensive lower access-rate and higher-latency memory (which may be DRAM). Such a 100% hit-rate packet-buffering system may operate by using parallelism on the memory interface to the DRAM devices in order to increase the memory bandwidth of the DRAM memory subsystem to be at least as large as the memory bandwidth of the SRAM-based cache memory.

For example, to implement a packet FIFO queue memory system for a router line card that receives data packets at a data rate of R bytes/second and sends data packets at a data rate of R bytes/second then the SRAM cache memory system must have memory bandwidth of at least 2R bytes/second. In order to use standard DRAM in such a memory system, parallel blocks of bytes are written to and read from the DRAM-based memory system such that the same memory bandwidth is achieved on the slower DRAM interface as is available on the faster SRAM interface. Thus, the parallel-accessed DRAM-based memory system must also have a memory bandwidth of at least 2R bytes/second. If DRAM devices with a random access-rate of T seconds are used (a new read request to any random memory location can be handled every T seconds), then at least b bytes must be transferred during each memory access such that a memory bandwidth of b/T bytes/second≧2R bytes/second is achieved. Thus, the number of bytes b must be greater or equal to 2RT bytes (b≧2RT bytes).

As set forth in the previous section, new embedded DRAM technologies have access-rates that are approaching the access-rates of high-performance SRAM devices. If a small amount of parallelism can be designed into a system, then an embedded DRAM-based memory system can provide easily provide the same throughput as an SRAM-based memory system. Furthermore, if the overall access-rate of a particular packet-buffering application is less than the access-rate of the embedded DRAM and parallelism is used on the embedded DRAM interface to handle the throughput requirements, then the controller logic in a packet-buffering system becomes much simpler to implement. Specifically, the SRAM cache only needs to store enough packets in the head of each queue to account for the latency of the embedded DRAM system since the embedded DRAM access-rate is sufficient to guarantee sustained performance for the packet-buffering application. Thus, a small amount of parallelism can increase the effective access-rate of the embedded DRAM such that the embedded DRAM can be used to achieve sustained performance for an application requiring a higher access-rate.

For example, in a typical packet-buffering application for a networking device that must handle 10 Gb/s per line wherein each data packet will have a minimum size packet 64 bytes there will be a minimum of 32 nanoseconds between each arriving data packet. Since both a data packet write and a data packet read must be performed for each data packet, the minimum packet access-rate of the memory system must no more than 16 nanoseconds in order to achieve sustained performance. With SRAM memory devices, this access-rate can be achieved easily by performing four consecutive memory accesses to sixteen consecutive locations. With embedded DRAM, a single sixty-four byte access every 16 nanoseconds would achieve the same throughput.

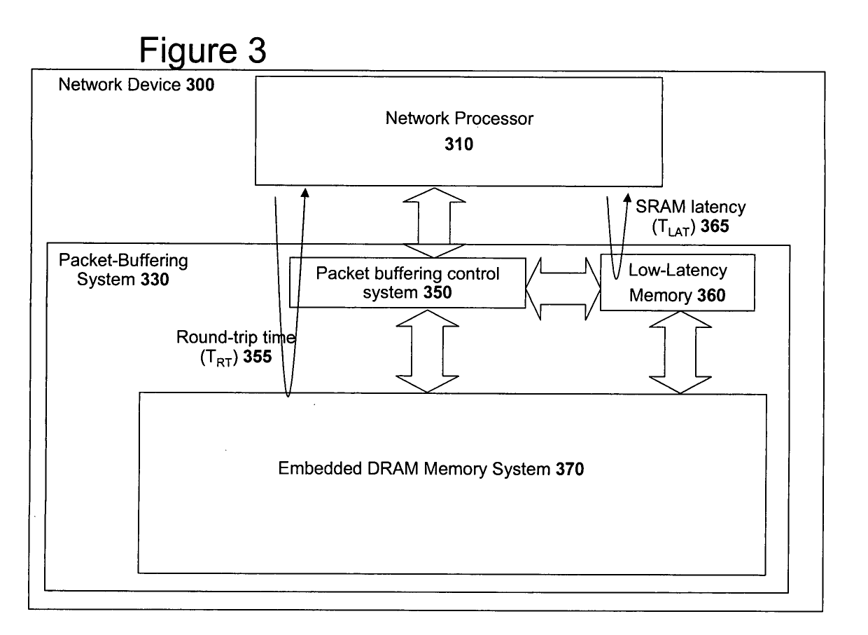

If sustained performance for the packet-buffering application can be achieved by using parallelism on the interface to the lower access-rate/higher-latency memory, then the controller logic in the packet-buffering system becomes much simpler to implement. Specifically, as previously set forth, the amount of higher access-rate/lower-latency memory only needs to be large enough to temporarily buffer data so as to handle the slower latency of the lower access-rate/higher-latency memory. An example of this technique is illustrated in FIG. 3.

FIG. 3 illustrates a block diagram of a network device 300 implemented with an embedded DRAM based packet-buffering system 330. The packet-buffering system 330 handles all the packet-buffering requirements for network processor 310 in network device 300. The embedded DRAM based packet-buffering system 330 is constructed using a combination of a large embedded DRAM memory system 370 and a smaller low-latency memory 360. The low-latency memory 360 may be a static RAM (SRAM) memory system. A packet-buffering control system 350 in the packet-buffering system 330 is responsible for using the embedded DRAM memory system 370 and the much smaller low-latency memory 360 in a manner such that all data packet read requests and all data packet write requests are handled without any delay visible to network processor 310.

As previously set forth, an embedded DRAM based packet-buffering system 330 only needs enough low-latency memory 360 to handle the total access latency time when accessing information the embedded DRAM memory system 370 provided that the embedded DRAM memory system can handle the maximum access-rate of the packet-buffering application. The total latency of accessing information from the embedded DRAM memory system 370 is conceptually illustrated in FIG. 3 as round-trip time T_{RT} 355. The round-trip time T_{RT} 355 is the amount of time that elapses from when a packet request is received at the packet-buffering control system 350 until packet data is presented to the network processor 310. Note that the total round-trip time TRT 355 may include the time required by the packet-buffering control system 350 logic to determine what data needs to be accessed and send a properly formatted memory request to the embedded DRAM memory system 370.

To provide adequate buffering for this access latency time, the low-latency memory 360 must store enough information to handle the round-trip time T_{RT} minus the normal latency time expected of an SRAM based system (T_{LAT}). Thus, the low-latency memory 360 must be able to supply T_{RT}-T_{LAT} seconds worth of packet data. So, if data packets are read out of a queue q at a sustained data rate of R_{q} bytes/second, that means R_{q} (T_{RT}-T_{LAT}) bytes of packet data must be stored in the low-latency memory 360 for packet queue q. Data packets must be buffered in the low-latency memory 360 for every data packet queue handled by the packet-buffering system 330. Thus, if all the data packet queues operate at the data rate of R bytes/second then the total amount of low-latency memory 360 required is QR(T_{RT}-T_{LAT}) bytes.

Packet Dropping with Packet Over-Writes

When a digital communication network is very congested, a network device may be forced to drop some data packets in order to reduce the network congestion. Many network devices implement data packet-dropping by simply overwriting a previously stored data packet in the packet queue. Specifically, if a networking device detects congestion and wishes to drop the last data packet added to a particular packet queue then that networking device may simply over-write the last data packet written to the packet queue with the next data packet received for that particular packet queue.

To implement a packet overwrite-based a packet-dropping scheme in the embedded DRAM packet-buffering system of FIG. 3, the packet-buffering controller 350 simply needs to maintain at least two queue tail pointers for each packet queue. A first tail pointer will point to the next available position in the packet queue tail (and empty memory location). A second tail pointer will point to the last data packet written to that packet queue. In one embodiment, the second tail pointer points to the beginning of the last data packet in the queue.

In normal operation, the first tail pointer will be used to add the next data packet received for that packet queue. After adding another data packet to the queue, both the first and second queue pointers wilt be updated accordingly. However, if there is congestion such that the last data packet should be dropped then the second tail pointer will be used such that the last packet on the queue will be over-written with the newly received data packet. A long series of data packets may be dropped by continually writing to the same memory location. In this manner, the networking device may continually drop data packets until an indication of reduced network congestion is received.

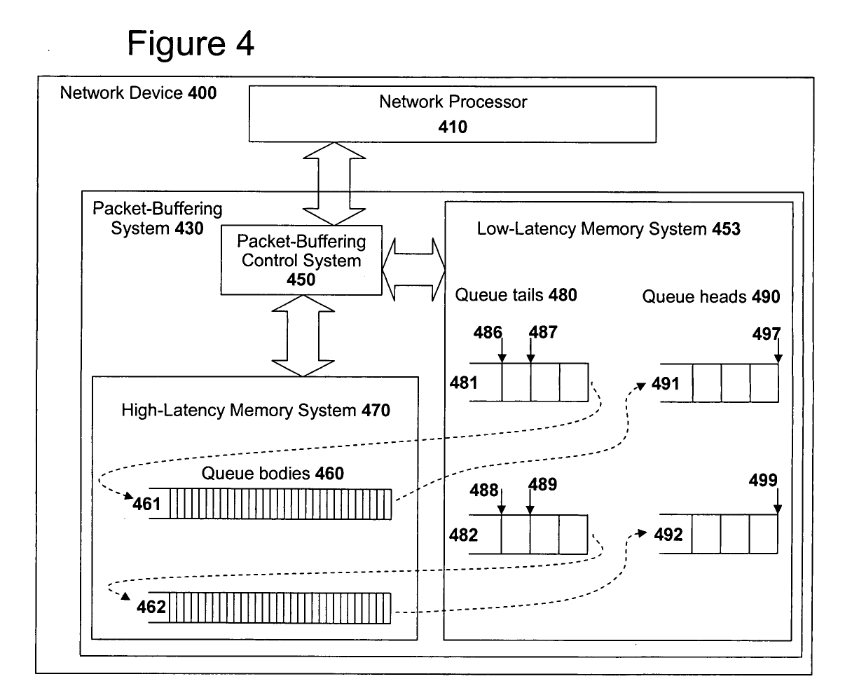

For example, FIG. 4 illustrates a block diagram of the network device 400 that contains a packet-buffering system 430 that maintains a set of queue pointers. The queue pointers indicate where the heads for each queue and the tails for each queue reside in low-latency memory 453. To implement packet dropping via packet over-writing, the packet buffer controller 450 should maintain two different tail pointers for each queue.

A first queue tail pointer will point to the next available location for writing the next packet received. A second queue tail pointer will point to the beginning of the last packet in the queue tail. For example, tail pointer 486 points to the next available location in the queue tail 481 and tail pointer 487 points to the beginning of the last packet in the queue tail 481. When a new packet is received, the packet-buffering controller will normally write the packet to the available location indicated by queue tail pointer 486 that points to the next available location. The pointers will be subsequently updated (the last packet pointer will point to the beginning of the newly added packet and the next packet pointer will point to a newly allocated memory location). However, if the network processor 410 indicates that it has dropped a packet by over-writing the last received packet, then the packet-buffering control system 450r will write to the location pointed to by the queue tail pointer 487 that points to the most recently added packet. In this manner, the packet that was previously stored at the location indicated by tail pointer 487 will be dropped and replaced by the most recently written packet.

### Full Random Access Pipelined ‘SRAM’ Memory

A more generic version of the embedded DRAM-based memory system of the previous section may be implemented to provide memory services for memory applications other than simply FIFO queue applications. Specifically, a fully random access memory system may be constructed using a combination of a small high-performance SRAM and a larger embedded DRAM that achieves a high memory access-rate with a relatively low cost due to the use of embedded DRAM.

This creation of a low-cost yet high-access-rate memory device can be achieved if the access rate of an embedded DRAM technology is similar to the access rate of an SRAM device. The main difference between an embedded DRAM memory system and an SRAM memory system is that the embedded DRAM memory system has a longer latency period. This means that even though an embedded DRAM memory system can be accessed at rate similar to an SRAM memory system, the embedded DRAM memory system requires more time before a particular piece of requested data becomes available.

In order to provide full random access, the memory system requires that the entire latency period for accessing the embedded DRAM to be observed. This cannot be avoided since any memory location may be accessed and all of the memory locations can not be represented in the smaller SRAM. However, additional memory read requests may be issued by a processor while the processor is waiting for the response to the initial memory request such that a sustained high access-rate is achieved. These additional memory read requests will be serviced at the same rate as the first memory request and with the same latency time. This hybrid embedded DRAM and SRAM approach has been dubbed a ‘virtual pipelined SRAM’. The virtual pipelined SRAM will respond to memory requests at the high access-rate of SRAM but with a larger latency time, such that it appears ‘pipelined’.

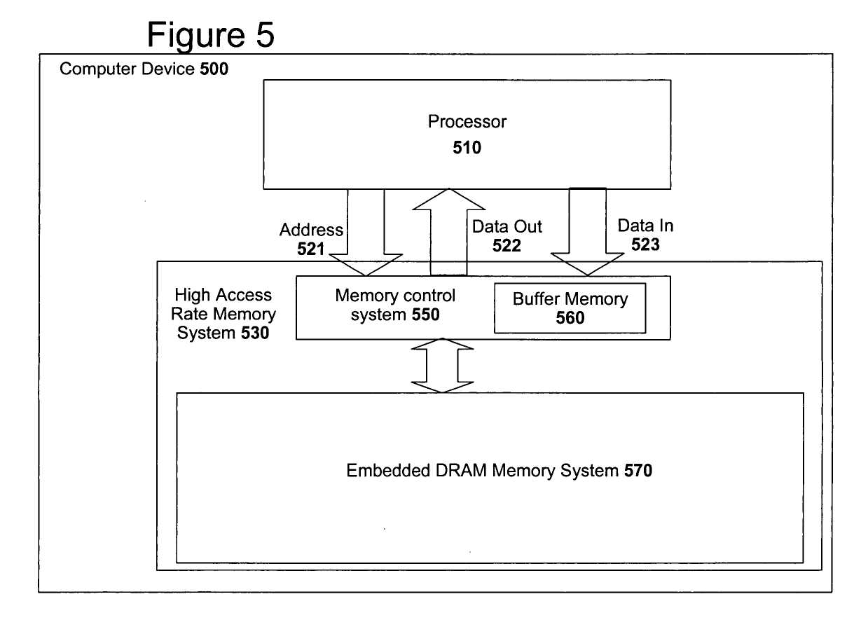

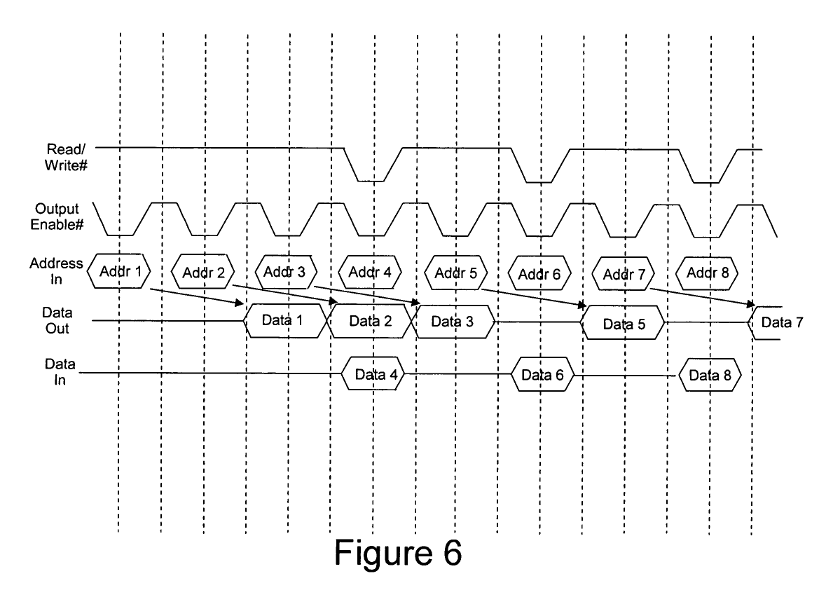

FIG. 5 illustrates a high-level block diagram of a computer device 500 implemented with a high access-rate memory system 530 (also known as a virtual pipelined SRAM memory system). The high access-rate memory system 530 is constructed using a combination of a large embedded DRAM memory system 570 and a much smaller low-latency memory buffer 560. The low-latency memory buffer 560 may be a static RAM (SRAM) memory system. A memory control system 550 handles all memory accesses to the high access-rate memory system 530 from a computer processor 510. The memory control system 550 is responsible for using the embedded DRAM memory system 570 and the much smaller low-latency memory buffer 560 in a manner that simulates a pipelined SRAM memory.

Memory Write Requests

To handle memory write requests, the memory control system 550 temporarily stores the data from memory write requests into the low-latency buffer memory 560. The memory control system 550 eventually writes the information stored in the low-latency buffer memory 560 to the embedded DRAM memory system 570.

If the latency period for the embedded DRAM memory system 570 is sufficiently short, then the low-latency buffer memory 560 may only consist of a simple write register. However, if there is a long latency period for the embedded DRAM memory system 570 (i.e. it takes a long period of time for data to be transferred to the embedded DRAM) the memory control system 550 may need to queue up a series of pending write requests (such as incoming data packets that must be stored) temporarily in the buffer memory 560.

Memory Read Requests

To handle random access memory read requests, the memory control system 550 must access data stored in the embedded DRAM memory system 570. As mentioned above, this will require the embedded DRAM to provide memory access-rates that are similar to the access-rates of SRAM memory systems.

The main difference between an embedded DRAM memory system and an SRAM memory system is that the embedded DRAM memory system has a longer latency period. This means that even though an embedded DRAM memory system can be continually accessed at an access rate similar to an SRAM memory system, the embedded DRAM memory system requires more time before a particular piece of requested data becomes available. Thus, the memory control system 550 must wait for requested data to be received from the embedded DRAM memory system 570. When the memory control system 550 receives the requested data from the embedded DRAM memory system 570, then the memory control system 550 returns that information to the processor 510.

However, during that waiting period caused by the memory latency, the memory control system 550 may receive additional memory requests from processor 510. The memory control system 550 will forward these additional memory requests to the embedded DRAM memory system 570. Thus, a queue series of memory requests can be handled at the full access-rate of the embedded DRAM memory system 570 in a pipelined manner.

As set forth in the previous memory write section, the memory control system 550 does not immediately store data into the embedded DRAM memory 570. Instead, the memory control system 550 temporarily stores the write data in the temporary buffer memory 560. Therefore, if a write request to a particular memory address is immediately followed by a read request for that same memory address, the recently written data will not yet be stored in the embedded DRAM 570. To handle such write followed by read from the same memory address situations, the memory control system 550 always examines the pending write requests in the buffer memory 560 to determine if there is a pending write to the same memory address specified in the read request. If there is one or more pending write request to that memory address, the data from the most recent matching write request must be returned. A Content-Addressable-Memory (CAM) may be used to identify such write-followed-by-read situations as is well-known in the art of pipelined microprocessor design.

FIG. 6 illustrates a timing diagram that illustrates one example of how a high access-rate memory system 530 may operate. In the example high access-rate memory system described by FIG. 6, the embedded DRAM memory can handle a memory write or read request every other clock cycle (the access-rate). However, that high access-rate memory system will not respond to each memory requests until the third clock cycle after a memory request (the latency period).

Referring to FIG. 6, a first memory read request is received at the first time period. However, the data will not be ready until three clock periods later such that the memory system does not provide an immediate response. Since the high access-rate memory system can continue to handle requests, it receives a second request at the third clock cycle. At the fourth memory cycle (the third cycle after the first memory request), the first piece of requested data is finally produced on a ‘Data Out’ bus 522. At the fifth memory cycle, a third memory request is made. Next, at the sixth memory cycle, the data from second data request (the one made at the third clock cycle) is provided on the Data Out bus 522. At the seventh clock cycle, a write request is made. Since data is concurrently being read out of the memory device, a second data bus (a ‘Data In’ bus 523) is used to receive the data that is being written. At the eighth clock cycle, the data from third data request (the one made at the sixth clock cycle) is provided on the Data Out bus 522.

As seen in FIGS. 5 and 6, an embedded DRAM memory system 570 can be used to create a high access-rate memory system that effectively functions as a ‘virtual pipelined SRAM’ memory system. The high access-rate memory system 530 of FIGS. 5 and 6 differs from traditional SRAM only in the fact that the latency to receive requested data is longer.

The memory system illustrated in FIGS. 5 and 6 is ideal for storage applications wherein a large amount of memory with a high access-rate is very important but the memory latency period is not as important. One example application may be that of a multi-threaded processor that must feed a series of computer instructions for each different application thread being executed by the processor. Since the multi-threaded processor performs context switches between the different executing threads, the memory latency period may not affect overall system performance since there is a latency time between each time slice given to each application thread that is caused by the context switch. However, the overall memory access-rate is important to the multi-threaded processor in order to be able to feed instructions to all of the different execution threads at the best possible rate.

### Efficient Memory Bandwidth Usage

In the various packet-buffering system embodiments of the present invention, slower-speed memory is arranged to perform large parallel reads and writes in order to provide high-speed performance. Specifically, information is cached in a low-latency memory and periodically written to or read from a high-latency memory in large blocks. Therefore, the performance of the high-latency memory interface is very important to the overall performance of the memory system. Thus, in order to optimize the performance of the memory system, the efficiency of the high-latency memory should be optimized.

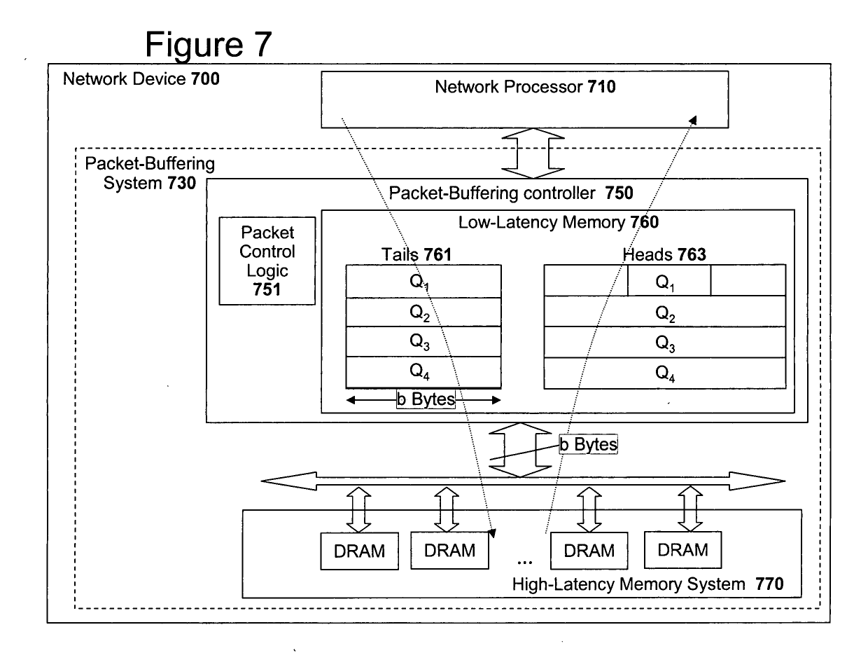

FIG. 7 illustrates a block diagram of one embodiment of a packet-buffering system 730 constructed according to the teachings of the present invention. As illustrated in FIG. 7, a packet-buffering controller 750 handles packet-buffering requests from a network processor 710. Packet-buffering control logic 751 in the packet-buffering controller 750 uses a low-latency memory 760 to store the heads and tails of various data packet queues. In the example embodiment of FIG. 7, there are heads and tails for four packet queues labeled Q₁ to Q₄ in the low-latency memory 760. The main bodies of packet queues Q₁ to Q₄ are stored in a high-latency memory system 770. In the example embodiment of FIG. 7, the high-latency memory system 770 is implemented with DRAM technology.

As the packet-buffering controller 750 receives packets from the network processor 710 for a particular packet queue, those packets will be stored in tail buffer 761 associated with that packet queue. When more data packets have been received than can fit in the allocated tail buffer in the low-latency memory 760, then some of the contents from the queue's tail must be transferred to the main body of the queue in the high-latency memory system 770.

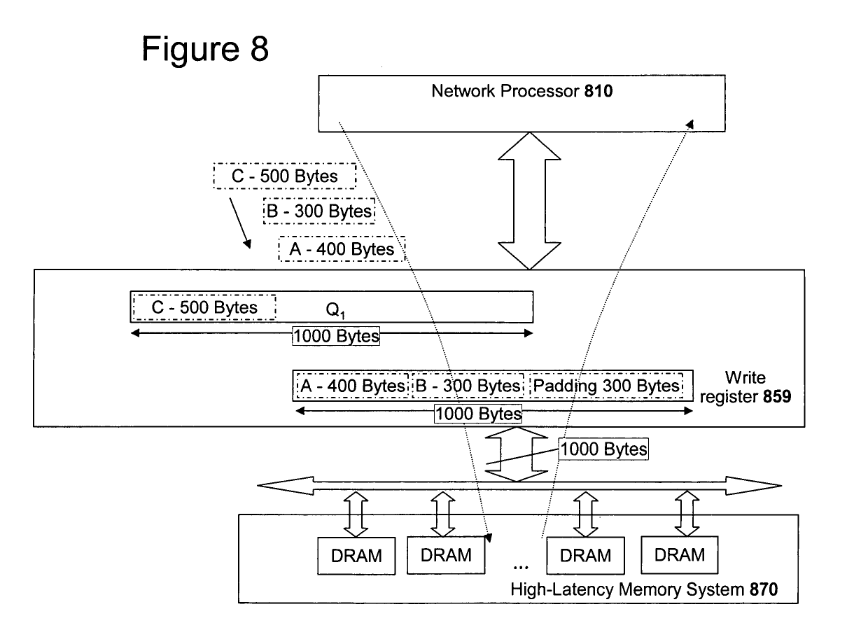

For example, FIG. 8 conceptually illustrates a packet-buffering system having a 1000 byte wide path to the high-latency memory system 870. If the packet-buffering system receives packet A with 400 bytes, packet B with 300 bytes, and packet C with 500 bytes, then the system will need to move packet information from the low-latency memory with a 1000 byte tail to the main body in high-latency memory 870 since the total number of bytes in the three packets (1200 bytes) exceeds the 1000 byte size for the queue tail.

One method of moving information from the queue's tail in low-latency memory to the queue's body in high-latency memory would be to write a 1000 byte block containing packet A with its 400 bytes, packet B with its 300 bytes, and padding of 300 bytes as illustrated in write register 859 in FIG. 8. (The 500 bytes from packet C would be stored in the queue's tail in low-latency memory.) However, this method is very inefficient. In this particular case, 30% of the 1000-byte block is merely padding. The inefficiencies can be much worse with many other data packet patterns. For example, if the write register 859 contains a 2 byte packet that is followed by a 999 byte packet, the two byte packet will be packed with 998 bytes of padding and then written into the high-latency memory 859. With such a memory system, the memory bandwidth efficiency of may be as low as 50% over the long term.

Thus, it can be clearly seen that such a padding system wastes memory bandwidth on the high-latency memory interface. Furthermore, this padding method also uses the storage capacity of the high-latency memory system very inefficiently since the extra padding data will fill up much of the available high-latency memory system. Thus, a system implemented in such a manner will require the high-latency memory system to have more memory capacity than should be necessary if not for the inefficiencies of the padding technique.

To remedy these inefficiencies, one embodiment of the present invention breaks up data packets such that nearly 100% of the memory bandwidth is used to carry actual data packet information. Specifically, each write to the high-latency memory or read from the high-latency memory is fully packed with packet data. If data packets do not evenly fit within a block, then the packets are broken up.

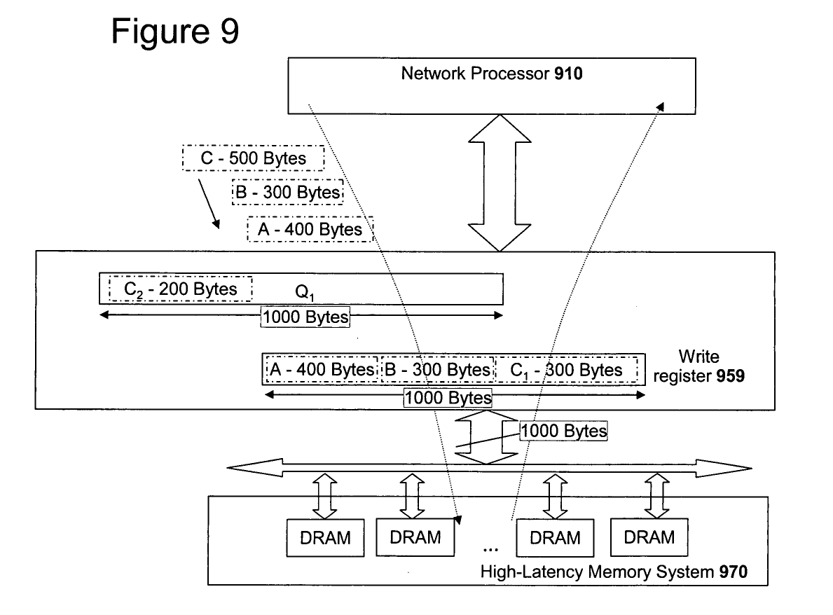

For example, FIG. 9 conceptually illustrates the example of FIG. 8 wherein the first three hundred bytes of Packet C (shown as Packet C₁) fill the remainder of the write register 959 and are written the high-latency memory system 970. The last two hundred bytes of packet C (shown as Packet C₂) remain in the queue tail in low-latency memory. In addition to the packet data, each 1000 byte block is accompanied by an indication of where the first packet begins (not shown). In this manner, the packet-buffering controller can determine where the first packet in a block begins and the remaining packets can be identified since each packet is encoded with a value indicating the packet's length.

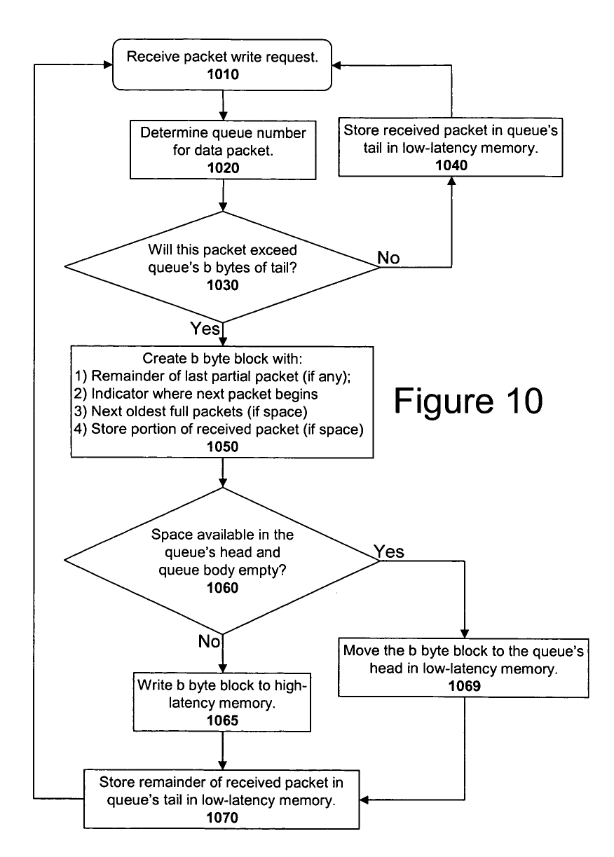

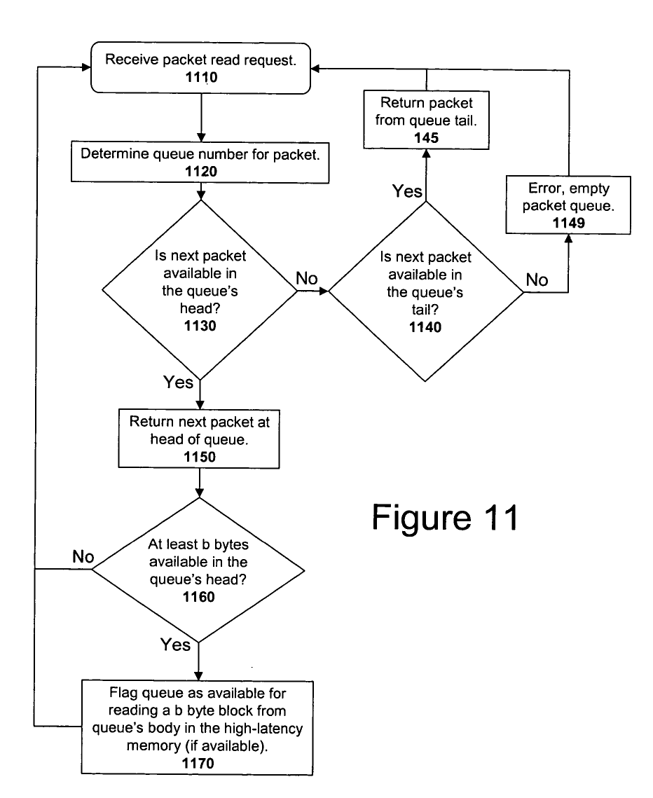

FIGS. 10 and 11 illustrate flow diagrams that describe how a packet-buffering controller that implements such a system would react to packet write requests and packet read requests, respectively. Note that these flow diagrams only illustrate one possible example.

Handling Packet Write Requests

Referring to FIG. 10, the packet-buffering controller receives a packet write request at step 1010. Next, at step 1020, the packet-buffering controller determines which queue that the packet is associated with. After determining the queue number, the packet-buffering controller determines if this packet will exceed the remaining space in the queue's b bytes of tail in the low-latency memory at step 1030. If the packet does not exceed the b bytes allocated for the queue's tail in low-latency memory, then the packet in stored in that queue tail in low-latency memory as set forth in step 1040. A number of packets may be stored in the queue's tail in this manner.

If the packet will exceed the b bytes allocated for the queue's tail in low-latency memory, then some of the packet data for that queue must be written into high-latency memory. Thus, at step 1050, a b-sized block is created to write into high-latency memory. The b-sized block first contains the remainder of a packet that was partially written to high-latency memory in the last write to the high-latency memory for that queue. Then an indicator that specifies where in the b-sized block the next packet begins is created. Then, at that specified location, the next oldest packets are placed into the b-sized block. Finally, a portion of the just received packet is placed into the b-sized block if there is any space remaining.

At step 1060, the packet-buffering controller determines if there is space in the queue's head in low-latency memory and the body of queue in high-latency memory is empty. This will generally occur when a queue is first created such that the queue is empty. If there is space in the head and the body of queue in high-latency memory is empty, then the b-size block is moved into the queue's head in the low-latency memory. If there is no space in the queue's head in low-latency memory, then the packet-buffering controller writes the b-sized block to the high-latency memory in step 1065. Finally, after moving the b-sized block to the head or into high-latency memory, the remainder of the received packet is stored in the queue's tail in low-latency memory at step 1070. (Note that this will be the entire packet if no portion of the packet was written in the b-sized block.)

Handling Packet Read Requests

Referring to FIG. 11, the packet-buffering controller receives a read request at step 1110. Next, at step 1120, the packet-buffering controller determines which queue that the packet is being requested from. After determining the queue number, the packet-buffering controller determines if a next packet is available in the queue's head in low-latency memory. If no packet is available, then the packet controller determines if a next packet is available in the queue's tail. This may occur if there are very few packets in the queue. If a packet is found in the tail, then that packet from the tail is returned at step 1145. This is referred to as taking the ‘cut-through’ path since the packet never passed through the high-latency memory. If no packet is found in the queue's tail, then the queue must be empty such that an error condition is flagged at step 1149.

Referring back to step 1130, if a next packet is available in the queue's head, then that packet is returned to the network processor that made the packet request at step 1150. The packet-buffering controller then proceeds to step 1160 to determine if some additional packet information should be retrieved from the high-latency memory such that it will be available. Specifically, at step 1160, the packet-buffering controller determines if there are at least b bytes of space available in the queue's head space in the low-latency memory. If there are not b bytes available, then the packet controller returns to step 1110 to await the next packet request. However, if there are at least b-bytes of space available for the queue's head, then the packet-buffering system will move information from the queue's body to the queue's head. In one embodiment, this is performed by having the packet-buffering controller flag the queue as available for reading a b-sized block from queue's body in the high-latency memory (if available) in step 1170. In one specific embodiment, a ‘longest queue first’ update system that is used to update the FIFO queue heads and tails will perform the actual move of the data.

### Packet-Buffering System Using Specialized Memory

A number of specialized memories have been developed to handle certain niche memory applications in a more efficient manner. For example, real-time three-dimensional computer graphics rendering requires a very large amount of memory bandwidth in order to access the model data and rapidly render images. Nvidia Corporation of Santa Clara, Calif. and ATI Technologies of Markham, Ontario, Canada specialize in creating display adapters for rendering real-time three-dimensional images on personal computers. To support the three-dimensional display adapter industry, memory manufacturers have designed special high-speed memories. One series of high-speed memories is known as Graphics Double Data Rate (GDDR) memory. Rambus, Inc. of Los Altos, Calif. has introduced a proprietary memory design known as XDR for graphics applications.

These specialized memories for graphics applications can be used to create high-performance packet-buffering systems. The specialized graphics memories are generally designed for large throughput such that large amounts of data can be read or written very quickly. Thus, such graphics memories are ideal for implementing a high-performance packet-buffering system. For example, FIG. 8 illustrates high-level block diagram of a packet-buffering system that reads and writes 1000 byte blocks to the high-latency memory system 870. The high-latency memory system 870 may be implemented with specialized graphics memories such that the high-throughput improves the efficiency of the packet-buffering system.

It should be noted that graphics memories can be used in packet-buffering applications in manner that achieves even greater performance gains than in a graphics application Specifically, the graphics memories may be used in parallel such that a very large block (such as the 1000 byte block in FIG. 8) can be accessed very rapidly. In most graphics applications such a wide memory accesses are not advantageous.

Different graphics memories are optimized in different manners. All of the different graphics memories can be used to implement packet-buffering systems. Two different examples are hereby provided. However, any specialized graphics memory can be used to create a packet-buffering system by improving the performance of the high-latency memory interface 175 as illustrated in FIG. 1A.

Multiple Pre-Fetch Implementations

Some specialized graphics memories can be placed into a mode wherein several successive memory locations are accessed with a single read request. For example, the graphics memory receiving a read request to memory location X may respond with the data from memory location X along with the data from memory location X+1, memory location X+2, and memory location X+3. In this manner, four pieces of data are quickly retrieved with a single read request such that the memory throughput is increased.

Furthermore, such memories can be arranged in a parallel configuration.

For example, in a parallel configuration with two memory devices, a single read to memory location X will obtain eight pieces of data. Specifically, memory locations X, X+1, X+2, and X+3 from both memories will be retrieved.

Double Pumping Memory Implementations

Some specialized memory devices commonly used in computer graphics adapters use a technique referred to as ‘double pumping’ in order to reduce the number of address pins on the memory devices. With double pumping, both the rising edge and the falling edge of a clock cycle are used to transmit address data. By using both the rising edge and the falling edge of a clock cycle, twice as much memory address information is transferred from the processor to the memory device during each clock cycle, hence the name ‘double-pumping.’ With twice as much memory address information transmitted per clock cycle then only half the number of address pins are needed to specify an address in the memory device.

For example, in a typical computer system A address lines may be required from the main processor to the memory system in order to address all of the memory locations in a memory system. If that computer system uses double-pumping memory devices then number of address lines from the processor to the memory system is reduced to A/2 address lines since A/2 address bits are transmitted on the rising clock edge and A/2 address bits are transmitted on the falling clock edge.

Such double-pumping memories can be used in a packet-buffering system such that even greater savings of address lines are achieved. Specifically, a number of double-pumping memory devices can be arranged in a parallel configuration such that the same few address lines are supplied to all the different double-pumping memory devices. With such a parallel configuration of double-pumping memory devices, the address line savings can become very significant. Specifically, in a packet-buffering system with A address lines coupled to N parallel memory devices then N*A/2 address bits are transmitted on the rising clock edge and N*A/2 address bits are transmitted on the falling clock edge. Thus, when N double pumping-memories are used in a parallel arrangement for the higher-latency memory in packet-buffering system, the number of address lines needed to address all of the memory locations is reduced to A/(2N).

### Packet-Buffering System Packaging

As set forth in the previous sections, the present invention teaches novel methods of implementing high-performance packet-buffering systems with lower-performance memory devices such as DRAM and embedded DRAM. These high-performance packet-buffering systems can be used to replace large expensive banks of SRAM memories on network devices. By using the teachings of the present invention, network devices that consume less power and generate less heat many be constructed at a lower cost.

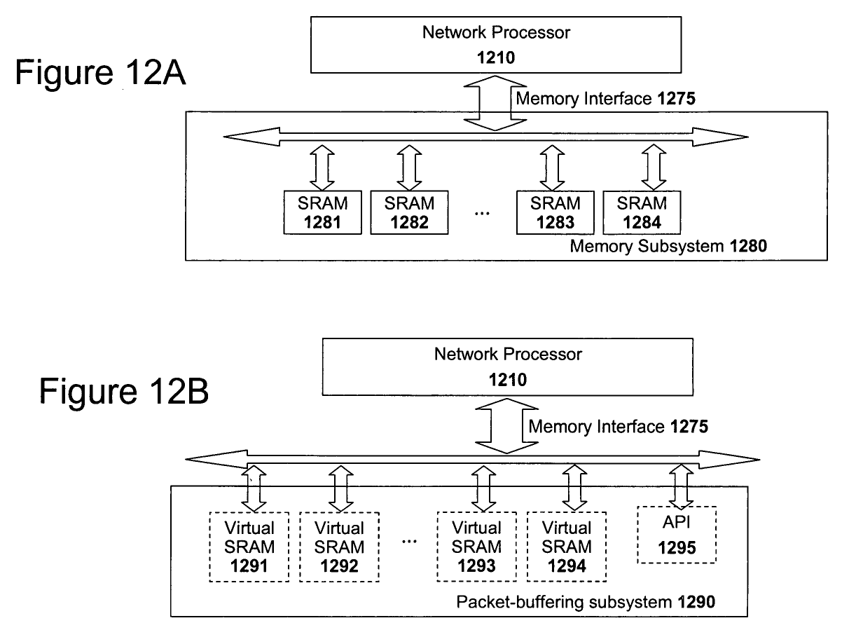

However, to quickly bring such packet-buffering devices to market, it may be advantageous to be ‘backwards-compatible’ with current network device memory system designs. For example, an existing high-speed network device may be implemented with SRAM memory devices. FIG. 12A illustrates a block diagram of a network device that has an SRAM-based memory subsystem 1280 that is used for packet-buffering. The example SRAM-based memory subsystem 1280 of FIG. 12A consists of four SRAM memory devices 1281, 1282, 1283, and 1284. To quickly provide a less expensive packet-buffering memory alternative, a packet-buffering system incorporating the teachings of the present invention may be implemented in a manner that uses a memory interface that is identical to the memory interface of existing network devices. For example, FIG. 12B illustrates the network device of FIG. 12A that uses an intelligent packet-buffering subsystem 1290 that is constructed from less expensive DRAM or embedded DRAM but uses the exact same interface as the SRAM-based memory subsystem 1280 in FIG. 12A. Specifically, the intelligent packet-buffering subsystem 1290 may include memory interfaces that mimic the SRAM memory devices (1281 to 1284) of FIG. 12A. These mimicked SRAM devices may be referred to as ‘virtual SRAM’ devices since they appear to operate exactly like an SRAM device even though the devices may contain other types of memory technology.

To construct a very efficient packet-buffering-system, the packet-buffering subsystem 1290 of FIG. 12B may be implemented within a single integrated circuit die by using standard CMOS logic with associated embedded DRAM. Such a single-chip packet-buffering system will cost far less than a four-chip SRAM memory subsystem. Furthermore, the single-chip packet-buffering system will require significantly less printed-circuit board real estate, generate less heat, and consume less power. Note that the systems of FIGS. 12A and 12B illustrate only one possible example. A single packet-buffering chip may be constructed and used to replace any number of SRAM memory devices.

The foregoing has described a number of methods for implementing high-speed packet-buffering systems that may be used in network devices. It is contemplated that changes and modifications may be made by one of ordinary skill in the art, to the materials and arrangements of elements of the present invention without departing from the scope of the invention.

1. A First-In First-Out (FIFO) memory subsystem for providing FIFO memory services at a guaranteed minimum rate, said FIFO memory system comprising:
a high-latency memory system, said high-latency memory system having a latency of L_{H} seconds;
a low-latency memory system, said low-latency memory having a latency of L_{L}, said low-latency memory system storing at least enough data to last L_{L}-L_{H} seconds at said guaranteed minimum rate; and
a FIFO memory controller, said FIFO memory controller responding to a read request by initiating a request for data from said high-latency memory system while immediately responding with data from said low-latency system.

2. The First-In First-Out (FIFO) memory subsystem of claim 1 wherein said high-latency memory system has a memory bandwidth sufficient to handle sustained FIFO requests at said guaranteed minimum rate.

3. The First-In First-Out (FIFO) memory subsystem of claim 1 wherein said FIFO memory system stores network packets.

4. The First-In First-Out (FIFO) memory subsystem of claim 1 wherein said high-latency memory system comprises embedded DRAM.

5. A pipelined memory subsystem, said pipelined memory system comprising:
a high-latency memory system, said high-latency memory system having a latency of L and an access-rate of A;
a pipelined memory controller, said pipelined controller responding to a read request by requesting data from said high-latency memory system while immediately responding with data from a previous read request, said pipelined memory controller responding to said read request within said latency L.

6. The pipelined memory subsystem of claim 5 further comprising:
a low-latency memory system, said low-latency memory system having an access-rate of at least A;

7. The pipelined memory subsystem of claim 5 wherein said pipelined memory system stores computer instructions.

8. The pipelined memory subsystem of claim 5 wherein said high-latency memory system comprises embedded DRAM.

9. The First-In First-Out (FIFO) memory subsystem of claim 1 wherein said FIFO memory controller responds with data retrieved from said high-latency memory system after responding with data from said low-latency memory system.

10. The First-In First-Out (FIFO) memory subsystem of claim 1 wherein said low-latency memory system stores at least enough data to last (L_{L}-L_{H} plus a logic processing time) seconds at said guaranteed minimum rate.

11. The First-In First-Out (FIFO) memory subsystem of claim 1 wherein said FIFO memory controller replenishes said low-latency memory system with data retrieved from said high-latency memory system after responding to a request.

12. The pipelined memory subsystem of claim 6 wherein said low-latency memory system buffers memory write requests in order to respond to a read request to a memory location having a pending write request.

13. A method of handling requests in a First-In First-Out (FIFO) memory subsystem that provides FIFO memory services at a guaranteed minimum rate, said method comprising:
receiving a read request;
initiating a request to a high latency memory system, said high-latency memory system having a latency of L_{H} seconds;
immediately respond to said read request with a low-latency memory system, said low-latency memory having a latency of L_{L}, said low-latency memory system storing at least enough data to last L_{L}-L_{H} seconds at said guaranteed minimum rate; and

14. The method of handling requests in a First-In First-Out (FIFO) memory subsystem as set forth in claim 13 wherein said high-latency memory system has a memory bandwidth sufficient to handle sustained FIFO requests at said guaranteed minimum rate.

15. The method of handling requests in a First-In First-Out (FIFO) memory subsystem as set forth in claim 13 wherein said FIFO memory system stores network packets.

16. The method of handling requests in a First-In First-Out (FIFO) memory subsystem as set forth in claim 13 wherein said high-latency memory system comprises embedded DRAM.

17. The method of handling requests in a First-In First-Out (FIFO) memory subsystem as set forth in claim 13 wherein said FIFO memory controller responds with data retrieved from said high-latency memory system after responding with data from said low-latency memory system.

18. The method of handling requests in a First-In First-Out (FIFO) memory subsystem as set forth in claim 13 wherein said low-latency memory system stores at least enough data to last (L_{L}-L_{H} plus a logic processing time) seconds at said guaranteed minimum rate.

19. The method of handling requests in a First-In First-Out (FIFO) memory subsystem as set forth in claim 13 wherein said FIFO memory controller replenishes said low-latency memory system with data retrieved from said high-latency memory system after responding to a request.
